(19) United States
(12) Patent Application Publication
(10) Pub. No.: US 2023/0306990 A1
(43) Pub. Date: Sep. 28, 2023

(54) DISK DEVICE AND CONTROL METHOD

(71) Applicants: Kabushiki Kaisha Toshiba, Tokyo (JP); Toshiba Electronic Devices & Storage Corporation, Tokyo (JP)

(72) Inventor: Ikuko IIDA, Yokohama Kanagawa (JP)

(21) Appl. No.: 17/903,845

(22) Filed: Sep. 6, 2022

(30) Foreign Application Priority Data
Mar. 22, 2022 (JP) 2022-045105

(51) Int. Cl. G11B 5/02; G11B 27/34

(52) U.S. Cl. CPC G11B 5/02; G11B 27/34; G11B 2220/2516

(57) ABSTRACT

According to one embodiment, a disk device includes a magnetic disk and a control circuit. The magnetic disk includes a shingled magnetic recording (SMR) region where data is recorded such that adjacent tracks are partially overlapped with each other by SMR. The control circuit writes, at a predetermined timing, dummy data to a location on the magnetic disk. The location is located after a position indicated by a write pointer. The control circuit executes scan processing after the writing of the dummy data.

### CROSS-REFERENCE TO RELATED APPLICATIONS

This application is based upon and claims the benefit of priority from Japanese Patent Application No. 2022-045105, filed on Mar. 22, 2022, the entire contents of which are incorporated herein by reference.

### FIELD

Embodiments described herein relate generally to a disk device and a control method.

### BACKGROUND

Many magnetic disk devices are used as storage devices for computer devices. In recent years, a technique referred to as shingled magnetic recording (SMR) has been developed to improve the recording density of data recorded in a magnetic disk of a magnetic disk device. SMR is also referred to as a shingled recording method from the data recording manner.

A magnetic disk is concentrically provided with a plurality of tracks. According to the SMR method, when data is written to the magnetic disk, adjacent tracks are partially overlapped with each other. With the SMR method, it is possible to narrow a track pitch and improve a recording density.

A self-test is executed to check the state of a disk. This self-test is, for example, scan processing for determining the presence or absence of a read error.

In the SMR method, however, an error occurs in a location after (or a location following) the position indicated by a write pointer even when reading/writing is actually possible, so that it is difficult to appropriately check the disk state.

Therefore, there is a need to appropriately check a disk state at the time when the write processing is executed by the SMR method.

### BRIEF DESCRIPTION OF THE DRAWINGS

FIG. 1 is a schematic diagram illustrating one example of a configuration of a magnetic disk device according to a first embodiment;

FIG. 2 is a schematic diagram illustrating an SMR method according to the first embodiment;

FIG. 3 is a schematic diagram illustrating one example of the positional relation between a write pointer and a track according to the first embodiment;

FIG. 4 is a flowchart of whole surface scan processing according to the first embodiment;

FIG. 5 is a flowchart of whole surface scan processing according to a second embodiment; and

FIG. 6 is a schematic diagram illustrating one example of the positional relation between a write pointer and a track according to a third embodiment.

### DETAILED DESCRIPTION

According to one embodiment, a disk device includes a magnetic disk and a control circuit. The magnetic disk includes an SMR region where data is recorded such that adjacent tracks are partially overlapped with each other by SMR. The control circuit is configured to write, at a predetermined timing, dummy data to a location on the magnetic disk. The location is located after a position indicated by a write pointer. The control circuit is configured to execute scan processing after the writing of the dummy data.

Disk devices and methods of controlling the disk devices according to the embodiments will be described in detail below with reference to the accompanying drawings. Note that the present invention is not limited by the embodiments.

### First Embodiment

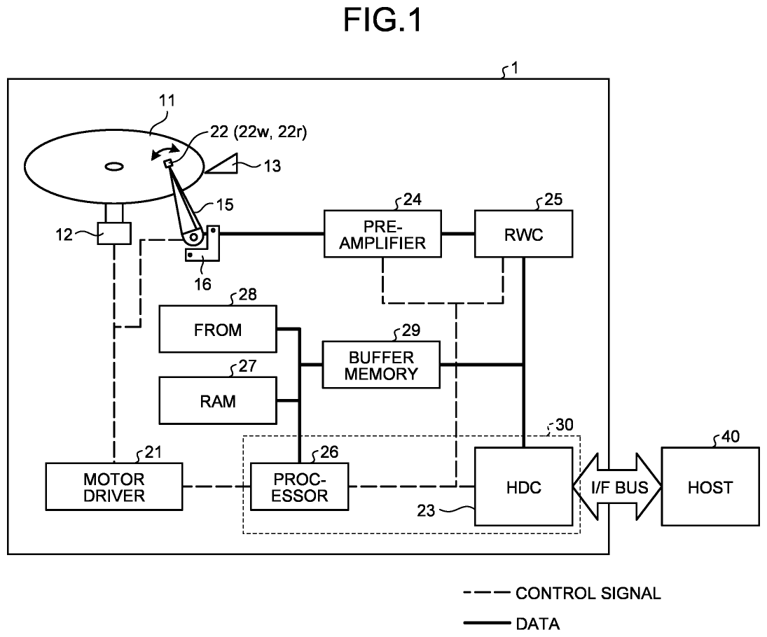

FIG. 1 illustrates one example of a configuration of a magnetic disk device 1 according to a first embodiment.

The magnetic disk device 1 is connected to a host 40. The magnetic disk device 1 is able to receive an access request from the host 40. Requests such as a write request for writing data and a read request for reading data each correspond to the access request.

The magnetic disk device 1 includes a disk medium 11, which is a magnetic disk. The magnetic disk device 1 writes data to the disk medium 11 and reads data from the disk medium 11 in response to an access request.

The magnetic disk device 1 writes data to the disk medium 11 through a magnetic head 22 and reads data from the disk medium 11 through the magnetic head 22. Specifically, the magnetic disk device 1 includes the disk medium 11, a spindle motor 12, a motor driver 21, the magnetic head 22, an actuator arm 15, a voice coil motor (VCM) 16, a lamp 13, a preamplifier 24, a read/write channel (RWC) 25, a buffer memory 29, and a control circuit 30. The control circuit 30 includes a hard disk controller (HDC) 23 and a processor 26.

The spindle motor 12 rotates the disk medium 11 at a predetermined rotation speed around a rotation axis. The rotation of the spindle motor 12 is driven by the motor driver 21.

The magnetic head 22 includes a write element 22w and a read element 22r. The magnetic head 22 writes and reads data to and from the disk medium 11 with the write element 22w and the read element 22r. Moreover, the VCM 16 moves the magnetic head 22 in a radial direction of the disk medium 11. The VCM 16 is provided at an end of the actuator arm 15. The motor driver 21 drives the VCM 16. For example, when the rotation of the disk medium 11 has stopped, the magnetic head 22 is moved onto the lamp 13.

In read operation, the preamplifier 24 amplifies and outputs a signal read by the magnetic head 22 from the disk medium 11, and then supplies the signal to the RWC 25. Moreover, the preamplifier 24 amplifies a signal for writing data to the disk medium 11 supplied from the RWC 25, and then supplies the amplified signal to the magnetic head 22.

The control circuit 30 executes write processing and read processing. The control circuit 30 manages the write pointer to execute the write processing on the basis of the write pointer. The write pointer indicates a logical address of a position subsequent to the end of the written data. The next writing is executed to the position indicated by the write pointer. The control circuit 30 may include elements such as a RAM 27, an FROM 28, the buffer memory 29, and the RWC 25. The control circuit 30 is one example of a controller.

The HDC 23 performs control of transmission and reception of data to and from the host 40 via an I/F bus, control of the buffer memory 29, error correction processing for read data, and the like.

The buffer memory 29 is used as a buffer for data transmitted to and received to and from the host 40. In particular, the buffer memory 29 is used to temporarily store data to be written to the disk medium 11.

The buffer memory 29 is constituted by, for example, a volatile memory capable of high-speed operation. A memory constituting the buffer memory 29 is not limited to a specific type. Examples for the buffer memory 29 include a dynamic random access memory (DRAM) and a static random access memory (SRAM).

The RWC 25 modulates a code of data written in the disk medium 11 supplied from the HDC 23, and supplies the data to the preamplifier 24. Moreover, the RWC 25 demodulates a code of a signal read from the disk medium 11 and supplied from the preamplifier 24, and outputs the signal to the HDC 23 as digital data.

The processor 26 is, for example, a central processing unit (CPU). A RAM 27, a flash read only memory (FROM) 28, and the buffer memory 29 are connected to the processor 26.

Examples of the RAM 27 include, for example, a DRAM and an SRAM. The RAM 27 is used for an operation memory by the processor 26. The RAM 27 is used as a region where firmware (program data) is loaded and a region where various pieces of management data are held.

The FROM 28 is one example of a nonvolatile memory. The processor 26 entirely controls the magnetic disk device 1 in accordance with firmware preliminarily stored in the FROM 28 and the disk medium 11. For example, the processor 26 loads the firmware preliminarily stored in the FROM 28 and the disk medium 11 into the RAM 27, and controls the motor driver 21, the preamplifier 24, the RWC 25, the HDC 23, and the like in accordance with the loaded firmware.

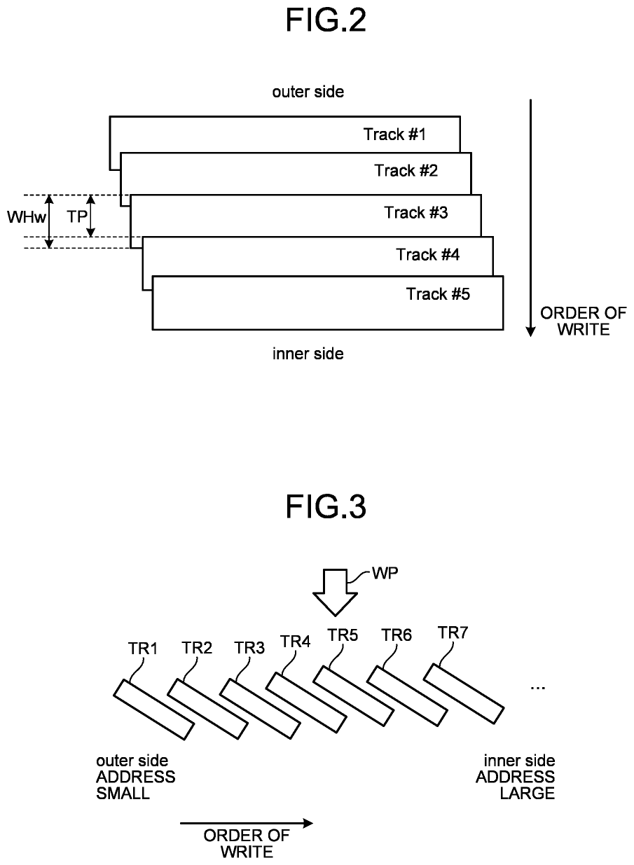

Note that the disk medium 11 has an SMR region where data is written by a method called shingled magnetic recording (SMR). Here, the SMR method will be described with reference to FIG. 2.

FIG. 2 is a schematic diagram illustrating an SMR method according to the first embodiment. SMR is a recording method of writing data by using the write element 22w such that adjacent tracks are partially overlapped with each other.

For example, in FIG. 2, a track #2 partially overlaps with a track #1. Moreover, a track #3 partially overlaps with the track #2. According to SMR, writing is repeated such that a track overlaps with part of an adjacent another track to which data has already been written.

With SMR, a track pitch (TP) between tracks becomes narrower than a core width (WHw) of the write element 22w of the magnetic head 22. As a result, recording density is enhanced.

Note that FIG. 2 illustrates a state of each track in a case where writing is performed from the outer side toward the inner side of the disk medium 11. The direction of writing is not limited thereto. The writing may be performed from the inner side toward the outer side of the disk medium 11.

The control circuit 30 of the magnetic disk device 1 executes scan processing at a predetermined timing. The scan processing is executed for inspecting a recording state of medium data stored in the disk medium 11. Examples of processing of inspecting a recording state of medium data may include background medium scan (BMS) processing and adjacent track interference (ATI) countermeasure processing. In the BMS processing, LBAs in all user data are sequentially scanned as a background task during an idle period, and a sector that may become a defective sector in the future is detected early. The ATI countermeasure processing is performed to remove influence, such as side erase generated by a data write operation to the disk medium 11, by rewriting data and prevent loss of the data. In this case, even if it is not the start time of the BMS processing or the ATI countermeasure processing, the BMS processing or the ATI countermeasure processing may be performed as long as it is a slack period.

When the magnetic disk device executes the scan processing on the SMR region, a track to be written next to a track written last by the magnetic disk device has a read error despite no trouble on the medium (that is, the disk medium 11). This is caused by repeatedly overlapping with part of an adjacent track to which data has already been written. Therefore, occurrence of an error is output despite no trouble on the medium.

Considering the above problem, in the embodiment described hereinafter, when the magnetic disk device 1 executes the write processing by the SMR method, the output of occurrence of an error despite no trouble on the medium is avoided, and thereby a disk state is appropriately checked.

In the magnetic disk device 1 according to the first embodiment, when executing the scan processing, the control circuit 30 makes a reference to a write pointer and executes the scan processing after writing dummy data to a location after a position indicated by the write pointer.

The control circuit 30 identifies the position indicated by the write pointer at the timing of executing the scan processing. Then, the control circuit 30 writes the dummy data to a track after the position of the write pointer.

FIG. 3 illustrates a positional relation between the write pointer and tracks. The control circuit 30 performs writing from an outer side to an inner side. In FIG. 3, it is assumed that a write pointer WP indicates the position of a track TR5. In this case, the control circuit 30 writes the dummy data to tracks after a track TR6. After that, the control circuit 30 entirely performs the scan processing (as whole surface scan processing). In this case, data is written to a location after the position of the write pointer WP, so that occurrence of a read error despite no trouble on the medium can be avoided.

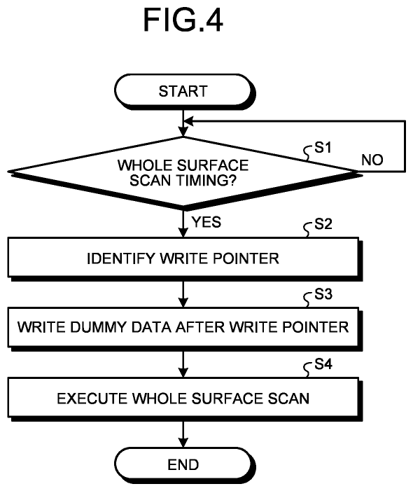

FIG. 4 is a flowchart of the scan processing in the first embodiment. When a timing of the whole surface scan has come (Step S1: Yes), the control circuit 30 identifies the position indicated by the write pointer WP (Step S2). Subsequently, the control circuit 30 writes dummy data to tracks located after the position of the write pointer WP (Step S3). Then, the control circuit 30 executes whole surface scan (Step S4).

Prior to the whole surface scan processing on the SMR region, the magnetic disk device 1 according to the first embodiment writes dummy data to a location after the position indicated by the write pointer WP, and executes the scan processing after writing the dummy data.

The magnetic disk device 1 executes the scan processing on finishing writing the dummy data to the location after the position of the write pointer WP, as described above. Therefore, it is possible to avoid the problem that a track next to the track written last has a read error despite no trouble on the medium. That is, the magnetic disk device 1 can appropriately check a disk state when executing the write processing by the SMR method.

### Second Embodiment

In a second embodiment, after executing the scan processing, when a location where a read error has occurred is a location after the position indicted by a write pointer, dummy data is written to that location, and the scan processing is executed again. A configuration of the magnetic disk device 1 is the same as that in the first embodiment.

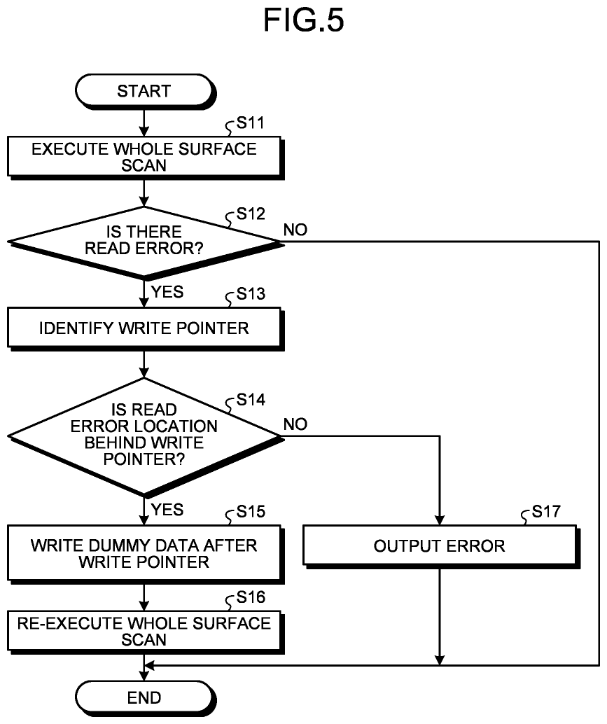

FIG. 5 is a flowchart of scan processing according to the second embodiment. The control circuit 30 executes the whole surface scan (Step S11). The control circuit 30 determines the presence or absence of a read error on the basis of a result of the whole surface scan (Step S12). When there is no read error (Step S12: No), the processing ends. In contrast, when there is a read error (Step S12: Yes), the control circuit 30 identifies a write pointer (Step S13), that is, recognizes the position indicated by the write pointer.

Then, the control circuit 30 determines whether or not a read error location is located after the position indicated by the write pointer (Step S14). When the read error location is after the position of the write pointer, there is a possibility that a read error may have occurred although there is no trouble on the medium. Therefore, when the read error location is after the position of the write pointer (Step S14: Yes), the control circuit 30 writes the dummy data to a location after the position of the write pointer (Step S15). Then, the control circuit 30 re-executes the whole surface scan (Step S16).

Note that, in Step S14, when the read error location is not located after the position of the write pointer (Step S14: No), a read error is considered to have occurred by some trouble on the medium. In this case, the control circuit 30 outputs the read error (Step S17).

As described above, when a read error is detected as a result of executing the whole surface scan processing and a location of the read error is located after the position of the write pointer, the magnetic disk device 1 according to the second embodiment writes dummy data to the location and re-executes the whole surface scan processing. In this manner, when the read error location is after the position of the write pointer WP, the magnetic disk device 1 re-executes the scan processing on finishing writing the dummy data to the location after the position of the write pointer WP. Therefore, it is possible to avoid the problem that a track next to the track written last has a read error despite no trouble on the medium.

### Third Embodiment

In a third embodiment, scan processing is executed even when the disk medium 11 includes not only the SMR region but a non-SMR region. In the non-SMR region, data is written by a method called conventional magnetic recording (CMR). CMR is a recording method in which writing is performed such that tracks do not overlap with each other.

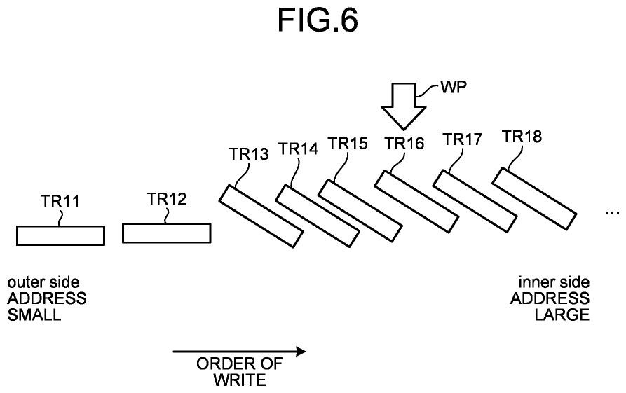

FIG. 6 illustrates an example of a disk medium including an SMR region and a CMR region. While tracks TR11 and TR12 are CMR regions, tracks TR13 to TR18 are SMR regions. The control circuit 30 performs writing in a direction from the track TR11 to the track TR18.

Moreover, it is assumed in FIG. 6 that the write pointer WP indicates the position of the track TR16. In this case, when it is a timing of the whole surface scan processing, the control circuit 30 identifies that the write pointer WP is directed to the track TR16. Subsequently, the control circuit 30 writes dummy data to tracks after the position indicated by the write pointer WP. Then, the control circuit 30 executes the whole surface scan processing.

Also, in a disk medium including a CMR region, the magnetic disk device 1 according to the third embodiment writes dummy data to tracks after the position of the write pointer WP at a timing of the whole surface scan processing. In this case, the magnetic disk device 1 executes the scan processing after writing the dummy data to the location after the position of the write pointer WP, it is possible to avoid the problem that a track next to the track written last has a read error despite no trouble on the medium.

Variations

Although not particularly mentioned in the above-described embodiment, the control circuit 30 may control retry processing. This will be specifically described below. When a read error occurs as a result of executing read processing on a predetermined track, the control circuit 30 executes processing of rereading the track in which the read error has occurred (hereinafter, referred to as retry processing). When a read error still occurs on a predetermined track even after the retry processing is executed a predetermined number of times (hereinafter, referred to as retry threshold), the control circuit 30 outputs a signal representing that the predetermined track has a read error.

For example, when the control circuit 30 executes the read processing and a read error occurs, the control circuit 30 may control retry processing on each track on the basis of the position indicated by the write pointer.

Specifically, the control circuit 30 may perform control so as to reduce the number of times of retry processing in a track adjacent to the position indicated by the write pointer. If retry processing is frequently performed in the track adjacent to the position of the write pointer, read processing on tracks around the position of the write pointer may be adversely influenced. The control circuit 30 can solve such a problem by restricting the number times of retries in the track adjacent to the position of the write pointer.

More specifically, when writing dummy data to a track at an adjacent location that is adjacent to and is after the position of the write pointer, the control circuit 30 performs control to reduce a retry threshold for this track at the adjacent location. In this manner, the control circuit 30 reduces the number of times of retries for a track adjacent to the position of the write pointer, so that adverse influence on read processing on surrounding tracks can be avoided.

Moreover, the control circuit 30 may write dummy data from a track at a position away by the predetermined number of tracks without writing the dummy data at the adjacent location after the position of the write pointer. In this case, the control circuit 30 can avoid an adverse influence on read processing on tracks around the position of the write pointer.

Although, in the above-described embodiments, a case where the present invention is applied to the magnetic disk device 1 has been described, the present invention may be applied to various other storage devices such as a solid state drive (SSD).

While certain embodiments have been described, these embodiments have been presented by way of example only, and are not intended to limit the scope of the inventions. Indeed, the novel embodiments described herein may be embodied in a variety of other forms; moreover, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a magnetic disk including a shingled magnetic recording (SMR) region where data is recorded such that adjacent tracks are partially overlapped with each other by SMR; and
a control circuit configured to
write, at a predetermined timing, dummy data to a location on the magnetic disk, the location being located after a position indicated by a write pointer, and
execute scan processing after the writing of the dummy data.

2. The disk device according to claim 1, wherein the predetermined timing is a timing before the execution of the scan processing.

3. The disk device according to claim 1, wherein the predetermined timing is a timing when, after the execution of the scan processing, the control circuit determines that a location where a read error of the magnetic disk has occurred is a location after a position indicated by the write pointer.

4. The disk device according to claim 1, wherein the control circuit is configured to restrict retry processing to be executed in an adjacent location on the magnetic disk, the adjacent location being adjacent to and located after a position indicated by the write pointer.

5. The disk device according to claim 4, wherein the control circuit is configured to reduce a number of the restriction of the retry processing when the dummy data is written to the adjacent location.

6. The disk device according to claim 1, wherein the control circuit is configured to write the dummy data to a location on the magnetic disk, the location being located a predetermined number or more of tracks after a position of the write pointer.

7. The disk device according to claim 1, wherein the magnetic disk further includes a conventional magnetic recording (CMR) region where data is recorded such that adjacent tracks do not overlap with each other.

8. The disk device according to claim 1, wherein the scan processing is whole surface scan processing.

9. The disk device according to claim 1, wherein the control circuit is configured to execute the writing from an outer side toward an inner side of the magnetic disk.

10. The disk device according to claim 1, wherein the control circuit is configured to write the dummy data to an adjacent location on the magnetic disk, the adjacent location being adjacent to and located after a position indicated by the write pointer.

11. A control method implemented by a disk device including a magnetic disk, the magnetic disk including a shingled magnetic recording (SMR) region where data is recorded such that adjacent tracks are partially overlapped with each other by SMR, the control method comprising:
writing, at a predetermined timing, dummy data to a location on the magnetic disk, the location being located after a position indicated by a write pointer; and
executing scan processing after the writing of the dummy data.

12. The control method according to claim 11, wherein the predetermined timing is a timing before the executing of the scan processing.

13. The control method according to claim 11, wherein the predetermined timing is a timing when, after the executing of the scan processing, the disk device determines that a location where a read error of the magnetic disk has occurred is a location after a position indicated by the write pointer.

14. The control method according to claim 11, further comprising restricting retry processing to be executed in an adjacent location on the magnetic disk, the adjacent location being adjacent to and located after a position indicated by the write pointer.

15. The control method according to claim 14, wherein the restricting includes reducing a number of the restricting of the retry processing when the dummy data is written to the adjacent location.

16. The control method according to claim 11, wherein the executing of the scan processing includes writing the dummy data to a location on the magnetic disk, the location being located a predetermined number or more of tracks after a position of the write pointer.

17. The control method according to claim 11, wherein the magnetic disk further includes a conventional magnetic recording (CMR) region where data is recorded such that adjacent tracks do not overlap with each other.

18. The control method according to claim 11, wherein the scan processing is whole surface scan processing.

19. The control method according to claim 11, wherein the executing of the scan processing includes executing writing from an outer side toward an inner side of the magnetic disk.

20. The control method according to claim 11, wherein the executing of the scan processing includes writing the dummy data to an adjacent location on the magnetic disk, the adjacent location being adjacent to and located after a position indicated by the write pointer.
